(19) United States
(12) Patent Application Publication
(10) Pub. No.: US 2007/0128083 A1
(43) Pub. Date: Jun. 7, 2007

(54) Microfluidic methods and apparatuses for sample preparation and analysis

(75) Inventors: Gregory R. Yantz, Cambridge, MA (US); Jonathan W. Larson, New Ipswich, NH (US)

Correspondence Address: WOLF GREENFIELD & SACKS, P.C., 600 ATLANTIC AVENUE, BOSTON, MA, 02210-2206, US

(73) Assignee: U.S. Genomics, Inc., Woburn, MA (US)

(21) Appl. No.: 11/484,330

(22) Filed: Jul. 11, 2006

Related U.S. Application Data
(60) Provisional application No. 60/700,480, filed on Jul. 18, 2005.
(60) Provisional application No. 60/700,490, filed on Jul. 18, 2005.

(51) Int. Cl. B01L 3/00

(52) U.S. Cl. 422/100

(57) ABSTRACT

Microfludic channels are constructed for use in preparing and/or analyzing samples. In one embodiment, a microchannel delivers multiple fluid samples from an upstream portion to a downstream portion of the channel where each of the fluid samples are separated from one another by a sheathing fluid that also travels toward the downstream portion. In another embodiment, a microchannel is constructed to create multiple elongational flows in series that can align polymers from a coiled state.

### RELATED APPLICATIONS

This application claims priority under 35 U.S.C. § 119(e) to U.S. Provisional Application Ser. No. 60/700,490, filed on Jul. 18, 2005 and U.S. Provisional Application Ser. No. 60/700,480, filed on Jul. 18, 2005, each of which is hereby incorporated by reference in its entirety.

### BACKGROUND OF INVENTION

1. Field of Invention

The invention relates to manipulating a sample, such as a sample that includes biological polymers, and more particularly to manipulating the sample in a microfluidic channel for subsequent analysis.

2. Discussion of Related Art

It is now possible to detect and analyze a polymer when the polymer is in an aligned or elongated state. U.S. Pat. No. 6,355,420, which is hereby incorporated by reference in its entirety, describes methods for linear analysis of polymers. The methods described therein provide methods for rapid detection of different components that comprise the polymer.

Sequence analysis of polymers has many practical applications. Of great interest is the ability to sequence the genomes of various organisms, including the human genome. Specific sequences can be recognized with a host of sequence-specific probes such as oligonucleotides, engineered proteins, and also synthetic compounds. In these sequence-specific approaches, there is sometimes a need to resolve the position of probes relative to one another, or to other features of the polymer, in order to generate a map of the polymer.

Linear analysis of polymers, such as DNA, may be accomplished by moving a detection zone over a fixed polymer, or by moving a polymer through a detection zone. These approaches make use of instrumentation and a detection signal to acquire information from the sequence-specific probes on the polymer when they are within the detection zone. For instance, fluorescence, atomic force microscopy (AFM), scanning tunneling microscopy (STM), as well as other electrical and electromagnetic methods, are suitable for capturing signals and thereby “reading” the sequence information of a polymer.

Improved analysis throughput can also be realized in systems that allow parallel processing of multiple samples. Present approaches that utilize microfluidics can require multiple, microfluidic channels to be constructed in close proximity to one another. Such approaches can result in microfluidic channels that are difficult to manufacture and that are prone to clogging. To this end, there is a need for a cost effective, microfluidic system that facilitates parallel processing of fluid samples and that is not prone to clogging.

Techniques exist for aligning polymers for subsequent linear analysis, such as those described in U.S. patent application Ser. No. 10/821664, filed on Apr. 9, 2004, now published as 20050112606. Some of such methods can be used to minimize the occurrence of hairpinned polymers during the alignment process. However, there is a need for methods that further minimize the occurrence of hairpinned polymers during the alignment process.

### SUMMARY OF INVENTION

According to another aspect of the invention, a microfluidic apparatus is disclosed that comprises a microchannel having opposed walls, an upstream portion and a downstream portion. The microchannel is constructed and arranged to transport fluid sample from the upstream portion toward the downstream portion. A plurality of sample introduction ports each provide a fluid sample to the microchannel such that the fluid sample from each of the plurality of sample introduction ports flows toward the downstream portion from the upstream portion. At least one sheathing fluid introduction port is positioned to provide a sheathing fluid to the microchannel such that the sheathing fluid from each sheathing fluid introduction port separates two of the plurality of fluid samples from one another as the fluid samples move toward the downstream portion.

According to another aspect, a method is disclosed that comprises moving polymers through an embodiment of the above described microfluidic apparatus.

In some embodiments, the plurality of sample introduction ports consist of two sample introduction ports. In other embodiments, the plurality of sample introduction ports comprise three sample introduction ports and the at least one sheathing fluid introduction port comprises two sheathing fluid introduction ports.

In some embodiments, the plurality of sample introduction ports are positioned such that the fluid sample from each of the sample introduction ports can be separated from one another by fewer than 1 micron as they move toward the downstream portion.

Some embodiments further comprise a flow controller to increase a flow rate of sheathing fluid through at least one of the at least one sheathing fluid introduction ports such that the sheathing fluid from the at least one sheathing fluid introduction port can further separate fluid samples from one another as the fluid samples move toward the downstream portion.

In some embodiments, the opposed walls form a funnel adapted to create a velocity gradient in the fluid samples.

In some embodiments, a pair of wall sheathing fluid introduction ports are positioned to provide a pair of wall sheathing fluids to the microchannel that each separate one of the opposed walls from one of the plurality of fluid samples as the fluid samples move toward the downstream portion. In one of such embodiments, the pair of wall sheathing fluids create a velocity gradient in at least some of the plurality of fluid samples. Some of such embodiments further comprise a flow controller adapted to adjust a flow rate of at least one of the pair of sheathing fluids to move the fluid samples closer to one of the opposed walls.

In some embodiments the microchannel is disposed on a microchip. In some of such embodiments, a first common supply port on the microchip provides fluid to each of the wall sheathing fluid introduction ports. In some of such embodiments, a second supply port on the microchip provides fluid to each of the wall sheathing fluid introduction ports and each of the sheathing fluid introduction ports. Still, some of such embodiments have a common supply port on the microchip that provides fluid to each of the plurality of sheathing fluid introduction ports.

Some embodiments further comprise a detection zone within the microchannel that detects any polymers present in fluid samples passing there through. The detection zone may consist of one detection zone adapted to detect polymers passing there through. The detection zone may comprise multiple detection zones each placed within the microchannel in separate positions associated with one of the fluid samples.

In some embodiments, the plurality of fluid samples contains a plurality of polymers. The polymers may include peptides. The peptides may be proteins. The polymers may be nucleic acids, such as DNA or RNA. The RNA may be miRNA, siRNA, or RNAi.

According to another aspect of the invention, a microfluidic apparatus is disclosed for manipulating a polymer in fluid. The apparatus comprises a microchannel having opposed walls, an upstream portion, and a downstream portion. The microchannel is constructed and arranged to transport a carrier fluid such that, when present in the carrier fluid, the polymer flows from the upstream portion toward the downstream portion. A first constriction creates a first elongational flow for manipulating the polymer within the carrier fluid as the carrier fluid moves toward the downstream portion. A second constriction creates a second elongational flow for manipulating the polymer within the carrier fluid as the carrier fluid moves toward the downstream portion. The second elongational flow is positioned downstream from and separated from the first elongational flow.

According to yet another aspect of the invention a method of manipulating a polymer in a carrier fluid with the above described microfluidic apparatus is disclosed.

In some embodiments, the microfluidic apparatus further comprises an intermediate portion to create a uniform velocity flow in the carrier fluid between the first elongational flow and the second elongational flow. The intermediate portion is positioned between the first and the second constriction. In some of such embodiments, the intermediate portion includes opposed walls of the microchannel that are spaced evenly from one another.

In some embodiments, the microfluidic apparatus further comprises a diffusion section to create a divergent flow between the first elongational flow and the second elongational flow. The diffusion section is positioned between the first and the second constriction. In some of such embodiments, the diffusion section includes portions of the opposed walls that provide successively greater cross sectional area to fluid that moves toward the second constriction. In some of such embodiments, the diffusion section includes channels adapted to remove fluid from the microchannel, such that the microchannel has successively greater cross sectional area available to fluid remaining in the channel that moves toward the second constriction.

In some embodiments, the first constriction may include a pair of channels adapted to introduce sheathing fluid into the microchannel. The first constriction may also include portions of the opposed walls that provide successively less cross sectional area to the fluid that moves in the first constriction toward the downstream portion.

The second constriction may include a pair of channels that introduce sheathing fluid into the microchannel The second constriction may also include portions of the opposed walls that provide successively less cross sectional area to fluid that moves in the second constriction toward the downstream portion.

In some embodiments, the second constriction is separated from the first constriction by a distance that allows a polymer that has been elongated in the first elongational flow to partially relax before entering the second elongational flow. In some embodiments, the distance is 20 microns.

In some embodiments, the microfluidic apparatus further comprises a third constriction to create a third elongational flow for manipulating the polymer within the carrier fluid as the carrier fluid moves toward the downstream portion. The third elongational flow is positioned downstream from and separated from the second elongational flow.

In some embodiments, the carrier fluid moves within the first elongational flow microchannel with a velocity between 0.1 and 20.0 mm/second.

In some embodiments, the polymer is a peptide. The peptide may be a protein. The polymer may be a nucleic acid, such as DNA or RNA. The RNA may be miRNA, siRNA, or RNAi.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a plan view of a microfluidic channel having multiple sample introduction ports, multiple wall sheathing fluid introduction ports, and a sheathing fluid introduction port for use in creating parallel sample flows in a common microfluidic channel;

FIG. 2 is a plan view of a microchannel configured for flow parallelization;

FIG. 3 is a plan view of a microchannel on a chip that has a common sheathing fluid supply port;

FIG. 4 is a plan view of the embodiment of FIG. 2 showing a representation of parallel sample fluid flow through the microchannel;

FIGS. 5A-5C provide a schematic representation of elongational flow acting to align a polymer from a coiled configuration;

FIGS. 6A-6C provide a schematic representation of elongational flow acting to place a polymer into a hairpinned configuration;

FIGS. 7A-7C provide a schematic representation of elongational flow acting to move a polymer from a hairpinned configuration to an aligned configuration;

FIG. 8 is a plan view of a microchannel having a funnel formed by opposed walls that may form a constriction to create elongational flow;

FIG. 9 is a plan view of a microfluidic channel with sheathing fluid introduction ports that provide sheathing fluid to the channel to create elongational flow;

FIG. 10 is a plan view of a microfluidic channel having diverging opposed walls that create divergent flow in fluid passing therethrough;.

FIG. 11 is a plan view of a microfluidic channel having fluid removal channels that create a divergent flow in fluid passing there through; and

FIG. 12 is a plan view of an embodiment of a microfluidic channel with features that create elongational flow, divergent flow, and uniform velocity flow.

### DETAILED DESCRIPTION

According to one aspect of the invention, a single microchannel can be adapted to deliver multiple fluid samples from an upstream portion to a downstream portion of the channel. Sheathing fluids can be provided to the microchannel to separate the fluid samples from one another as all of the fluids move toward the downstream portion. Use of such sheathing fluids to separate fluid samples can allow fluid samples to be placed closer to one another than might otherwise be possible. By way of example, in some embodiments, multiple fluid samples may be passed through a common microchannel, where each of the fluid samples are separated from adjacent fluid samples by as few as one micron.

As used herein, the term “sample fluid” refers to any fluid provided to the microchannel that contains sample of interest. The sample can comprise polymers, any other agents described herein, and other agents, as aspects of the invention are not limited in this manner. As used herein, the term “sheathing fluid” refers to any fluid introduced to the microchannel that is used to separated sample fluids from one another or any other entities, even if only temporarily.

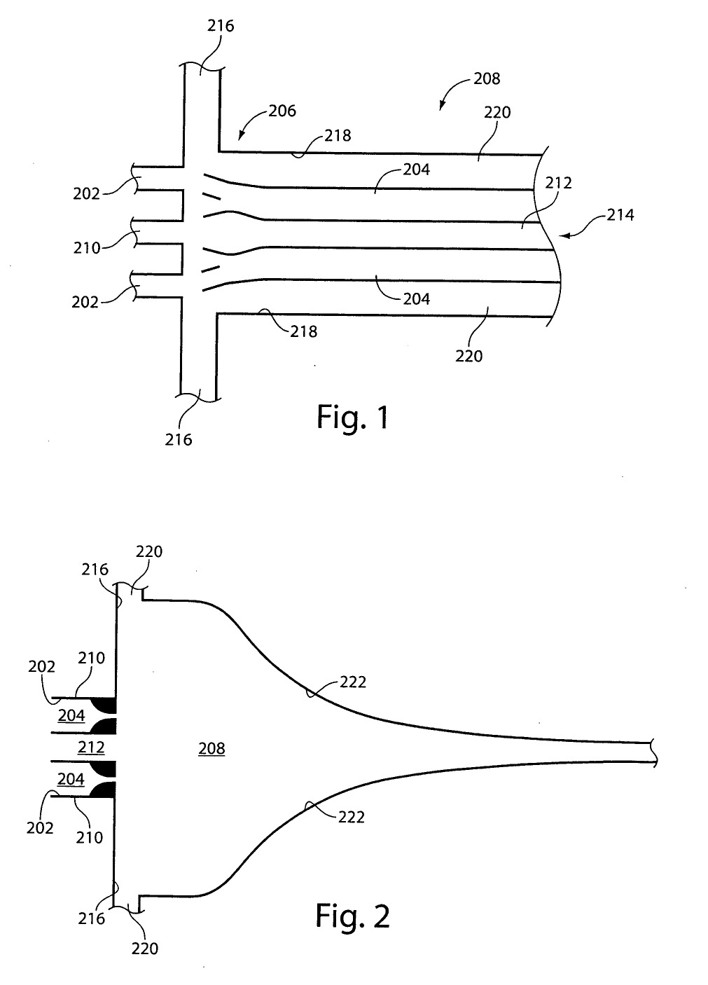

FIG. 1 shows an embodiment of the invention where two sample introduction ports 202 each provide a fluid sample 204 to the upstream portion 206 of a microchannel 208. The microfluidic device also includes a sheathing fluid introduction port 210 adjacent to the upstream portion. The sheathing fluid introduction port 210 can be positioned such that the sheathing fluid 212 is introduced to the microchannel to separate each of the fluid samples 204 as they move toward the downstream portion 214.

FIG. 1 also shows a pair of wall sheathing fluid introduction ports 216 located near opposed walls 218 of the microchannel near the upstream portion. Each of the wall sheathing fluid introduction ports can provide a wall sheathing fluid 220 to the microchannel. The wall sheathing fluids 220 can each separate one of the opposed walls 218 from an adjacent fluid sample as the fluid sample moves toward the downstream portion 214 of the microchannel.

Some embodiments of the microchannel have opposed walls 218 that cause a velocity gradient to be created within the fluid samples as they move toward the downstream portion. For example, the embodiment of FIGS. 2 and 4 have opposed funnel shaped walls 222 that create elongational flow in each of the fluid samples. FIG. 4 represents flow of sample fluid through the funnel-shaped microchannel, like that of FIG. 2, as was computed using a model based on computational fluid dynamics. Wall sheathing fluid 220 introduced into the microchannel 208 can also create a velocity gradient. Such wall sheathing fluids 220 can be used in addition to or in place of a funnel shaped portion of the microchannel, as the invention is not limited to any one device for creating elongational flow. Still, other embodiments of the invention may not create elongational flow at all, such as the embodiment of FIG. 1.

Embodiments of the invention can have features that prevent the fluid samples from mixing with sheathing fluids, or that promote mixing between the sample and sheathing fluids. By way of example, the introduction ports 210 may direct sheathing fluids 212 into the microchannel such that they impinge on fluid samples 204 to promote mixing. In other embodiments, the sheathing fluids 212 can be introduced into the microchannel 202 such that the stream lines of both the sheathing and fluid samples 204 are flowing parallel to one another so as to minimize mixing. Still, in some embodiments, the fluid samples 204 and sheathing fluids 212 can have different viscosities, or other characteristics to prevent or promote mixing there between.

Although FIGS. 1 and 2 show two fluid samples 204 and a single sheathing fluid 212 in the microchannel 202, other embodiments may include any number of fluid samples and interleaved sheathing fluids. By way of example, in some embodiments as many as one hundred fluid samples can be passed down a single microchannel, each separated from one another by sheathing fluids.

Providing multiple fluid samples in a single microchannel can prevent the microchannel from clogging. A single, wider microchannel associated with the delivery of multiple fluid samples is less prone to clogging than narrower microchannels used to each pass single fluid samples. Polymers, reactants, coagulated debris, foreign particles, or other components that are passed through microchannels, whether intentionally or not, are less likely to become lodged in a microchannel that is wider, like that of FIGS. 1 or 2.

A single microchannel adapted to pass multiple fluid samples does not require sharp angles along the flow paths of the fluid samples. Sharp angles within a flow path, such as angles less than 120 degrees, or even less than 135 degrees, can cause polymers to become tangled or caught within a microchannel. When multiple fluid samples are passed through a single microchannel by way of sample introduction ports, like those shown in FIG. 1, there is less need for microchannels with sharp angles.

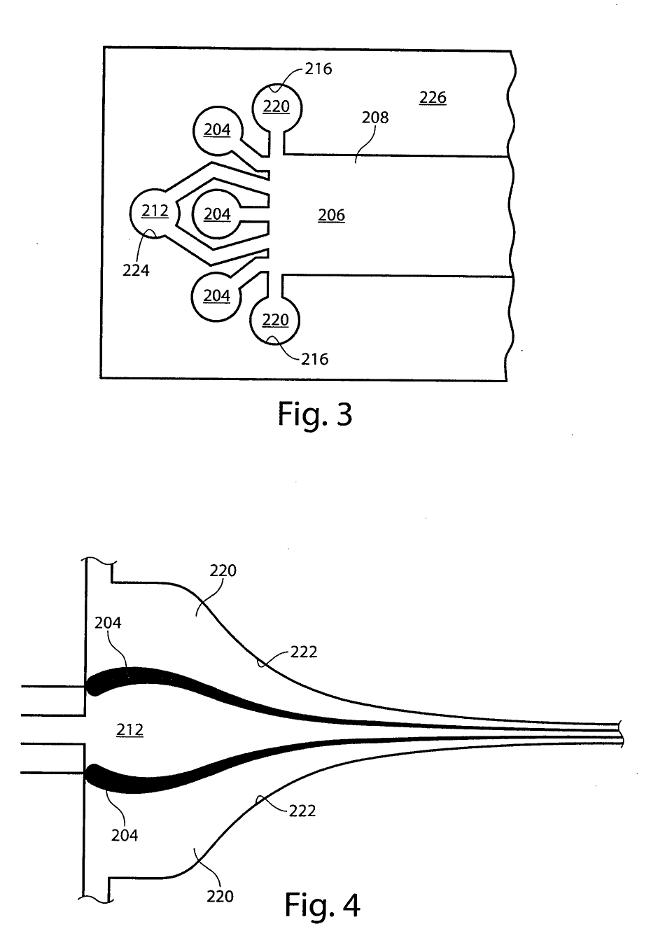

FIG. 3 shows a microchannel adapted to provide three separate fluid samples 204 to a microchannel 208, each separated from adjacent fluid samples by a sheathing fluid 212. The microchannel resides on a microchip 226. Each of the sheathing fluid introduction ports of the microchannel receive sheathing fluid from a single, common supply port 224 on the microchip. Similarly, in other embodiments, each of the opposed wall sheathing fluid introduction ports can receive wall sheathing fluid from a common supply port on the microchip. Such arrangements may be beneficial in that they can reduce the total number of supply ports that a single microchip must use to interface with an apparatus that supplies sheathing and/or fluid samples to the microchip. Although FIG. 3 shows one embodiment that has a single port for the sheathing fluids, other configurations are possible, as aspects of the invention are not limited to the arrangement shown in FIG. 3. As used herein, the term “microchip” refers to any portable element that contains a microchannel. By way of example, a microchip can comprise a silicone chip into which the microchannel is formed. However, other types of microchips are possible, as aspects of the invention are not limited in this regard.

Embodiments of the invention can also include a microchannel that has separate supply ports that communicate with each of the wall sheathing fluid introduction ports. Each of the separate supply ports can interface with a flow controller. The flow controllers can be used to separately control flow rates of each of the wall sheathing fluids. In this regard, a flow rate of one of the wall sheathing fluids may be increased relative to the other such that the wall sheathing fluid occupies a greater cross-sectional area of the microchannel, thereby pushing each of the fluid samples, and other sheathing fluids further away from the corresponding wall of the microchannel. Similarly, the flow rate of one of the wall sheathing fluids can be reduced to compensate for an increase in the other wall sheathing fluid, or may be reduced to allow other sheathing and fluid samples to occupy more space within the microchannel. Some examples of flow controllers include centrifugal pumps, positive displacement pumps, whether used to create vacuum or pressure. However, it is to be appreciated that flow controllers are not limited to being pumps, as aspects of the invention are not limited in this regard Additionally, flow controllers can include computers, programmable logic controllers, and the like that may used to operate other components that control flow.

Illustrative embodiments of the invention can also have separate supply ports for each of the sheathing fluid introduction ports. Each of the supply ports can also be attached to a flow control device of a mating component. Flow controllers can be used to control flow rates of each of the sheathing fluids. When desired, a given sheathing fluid flow rate can be increased such that the corresponding sheathing fluid will occupy a greater cross-sectional area of the microchannel. In this regard, the sheathing fluid may further separate fluid samples from one another as the fluid samples flow toward the downstream portion. Conversely, a flow rate can be reduced such that adjacent fluid samples are moved closer to one another as they move toward the downstream portion.

Aspects of the invention not limited to any particular number of sample fluids that may be passed through a microchannel. As used herein with reference to the number of fluid samples or sheathing fluids, the term “plurality” can refer to as many as 10⁶ or fewer then 10⁴, fewer than 10³, fewer than 10² or as few as 2, as aspects of the invention are not limited in this regard.

In still some embodiments, a detection zone can be located within a downstream portion of the microchannel. The detection zone can be used to detect or analyze polymers that reside within any of the fluid samples passing there through. The detection zone can comprise a single detection zone, or multiple, independent detection zones, such as may be provided by a linear CCD array such as is described in U.S. application Ser. No. 11/210,155, filed Aug. 23, 2005, which is hereby incorporated by reference in its entirety. In such an embodiment, each pixel of the CCD array may be associated with one of the multiple fluid samples that pass through the microchannel. Each of the fluid samples may be directed to one of the separate detection zones by adjusting flow rates of any of the fluid samples, sheathing fluids, and/or wall sheathing fluids. In other embodiments, the flow rates of each of the fluids and the configuration of the microchannel may be tuned ahead of time such that each of the fluid samples consistently pass through a designated detection zone.

According to another aspect of the invention, a microchannel can be constructed to create multiple elongational flows in series. The elongational flows are separated from one another such that a polymer contained in a carrier fluid passing through the microchannel is exposed to a first elongational flow and then is allowed to partially relax. After relaxing, the polymer is exposed to a second elongational flow. Subjecting the polymer to multiple elongational flows sequentially in this manner can decrease the time that it takes to elongate a polymer from a coiled or hairpinned configuration.

Elongational flow 310 can elongate a polymer 302 from a coiled configuration 304 into a hairpinned 306 or 308 aligned configuration. Elongational flow can also elongate a polymer from a hairpinned configuration 306 to an aligned configuration 308, if the hairpinned polymer resides within the elongational flow for a sufficient duration. However, in some applications it is desirable to elongate polymers from a hairpinned configuration in a shorter duration than can be accomplished with only a single elongational flow. As used herein, the term “elongational flow” refers to fluid that is moving such that the fluid is accelerating as it moves downstream. Elongational flow can alternately be described as a flow that includes a velocity gradient. In some instances, elongational flow can occur in conjunction with some shear between adjacent streamlines, but does not have to. It can also occur in conjunction with the streamlines being forced closer toward one another, or equivalently, being focused.

“Stretching efficiency” as used herein is a measure of how effectively a microfluidic device elongates polymers. Specifically, stretching efficiency represents the percentage of polymers fed through a microfluidic device, such as a microchannel, that achieve an aligned or elongated configuration after traversing a common distance through the device. It is to be understood that the terms “aligned” and “elongated”, as used herein, both refer to a polymer configured in a straight line from one end to the other.

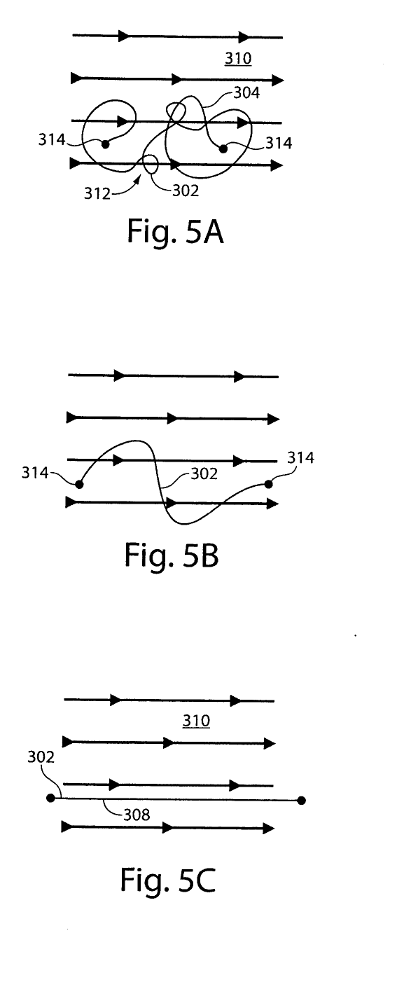

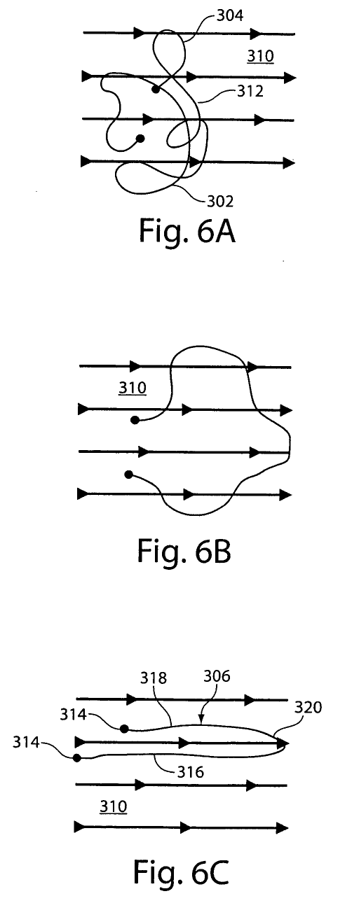

The configuration of a coiled polymer 304 as it enters elongational flow 310 can affect how long it takes the polymer 302 to move to an aligned configuration. Polymers that enter elongational flow with the central body portion 312 of the polymer located between each of the ends 314 of the polymer in a direction parallel to the flow will likely be aligned more quickly. FIGS. 5A-5C show a polymer aligned in such a configuration. FIGS. 6A-6C show a polymer having most of its central portion 312 located either upstream or downstream of each end 314 of the polymer 302. Polymers that enter elongational flow configured as shown in FIG. 6A can take longer to move to an aligned configuration in elongational flow.

In elongational flow, streamlines of a carrier fluid accelerate in a direction parallel to the flow. As a polymer 302 enters the elongational flow 310, fluidic drag forces are applied to portions of polymers that lie in the accelerating streamlines. In this manner, fluidic drag forces can act in a distributed manner along the length of the polymer.

When the polymer enters elongational flow with much of the polymer body 312 located between each of its ends 314 in a direction parallel to the flow, the distributed fluidic drag forces will more likely pull each of the ends 314 of the polymer in opposite directions in the channel. In this manner, the elongational flow can act rather rapidly to align the polymer without the polymer ever entering a hairpinned configuration. FIGS. 5A-5C show a schematic representation of this process.

On the other hand, when a polymer 302 enters elongational flow 310 with much of the polymer body 312 located either upstream or downstream of each end 312 of the polymer, the fluidic drag forces will more likely pull each of the ends 314 of the polymer in the same direction. The central body portion 312 will typically be pulled in the opposite direction. In this manner, as represented by FIGS. 6A-6C, the polymer can be manipulated into a hairpinned configuration 306.

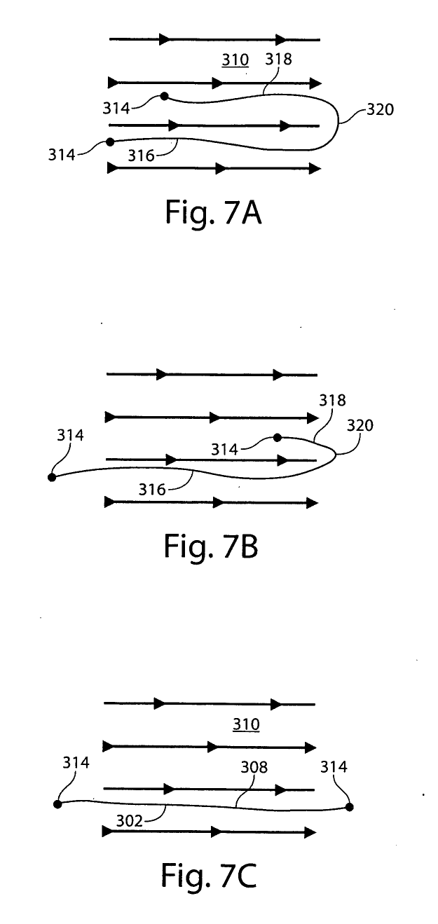

After further residence in elongational flow, a hairpinned polymer 306 can be manipulated into an aligned configuration 304. When in elongational flow, fluidic drag forces act on each leg of the polymer. Due to the distributed nature of the fluidic drag forces, the net force acting on the longer leg 316 of the polymer will typically be larger than the net force acting on the shorter leg 318. After time, the larger net force acting on the longer leg 316 can pull the shorter leg 318 of the polymer about its hairpinned end 320 until the entire polymer 302 is elongated, as schematically represented in FIGS. 7A-7C. Hairpinned polymers with one leg much shorter than the other can be aligned more quickly in this manner. Hairpinned polymers with legs substantially even in length typically take longer to align, and may not align at all, even after extended residence in elongational flow.

Polymers, or portions of polymers, can relax and reconfigure upon being removed from elongational flow. Eventually, polymers that are removed from elongational flow will relax completely and then return to a coiled configuration. Typically, this reconfiguration begins at the ends of the polymer, which move and then coil about themselves. In this manner, the ends 314 of a hairpinned polymer 306 that are removed from elongational flow can move away from one another in a direction parallel to flow. Sometimes this results in the body 312 of the polymer no longer being positioned primarily upstream or downstream from both ends 314 of the polymer. When the polymer reconfigures itself upon exiting a first elongational flow, it can be manipulated to an aligned state by a downstream elongational flow more quickly if it enters the second elongational flow before it coils too much.

The ends 314 of hairpinned polymers 306, upon relaxing when the polymer exits a first elongational flow, may also move apart from one another in a direction perpendicular to flow. When in the elongational flow 310, the ends of a hairpinned polymer frequently lie along common or adjacent streamlines. After ends are moved perpendicular to the direction of flow, they will reside in streamlines that are further separated from one another. Upon entering the second elongational flow, particularly if the elongational flow also moves the streamlines closer to one another, such as in focused flow that also focuses streamlines closer to one another, the polymer will likely be removed from its hairpinned configuration.

Divergent flow can be used to help reconfigure a polymer from a hairpinned configuration when the polymer exits elongational flow. Divergent flow has streamlines that move away from one another in a direction perpendicular to flow. The separating streamlines can help reconfigure a polymer such that upon entering a second elongational flow, the ends of the polymer will be further from one another in either a direction perpendicular or parallel to flow. As discussed above, reconfiguring the polymer in this manner can help a downstream elongational flow manipulate the polymer to an elongated configuration. Divergent flow, in some embodiments, can also have streamlines that slow down as they move further downstream. Streamlines that slow down can help reconfigure a hairpinned polymer such that upon entering a second elongational flow, the polymer can be elongated more easily.

Polymers can be fully removed or only partially removed from a first elongational flow before entering a second elongational flow. Whether the polymer is partially or completely removed depends on the length of the polymer and the separation distance between the first and the second elongational flows. In some applications, it is desirable to only allow a polymer to be partially removed from elongational flow, which can prevent the polymer from coiling too far upon exiting the elongational flow. In other applications, polymers may be elongated more rapidly by a second elongational flow after having been fully removed from the first elongational flow.

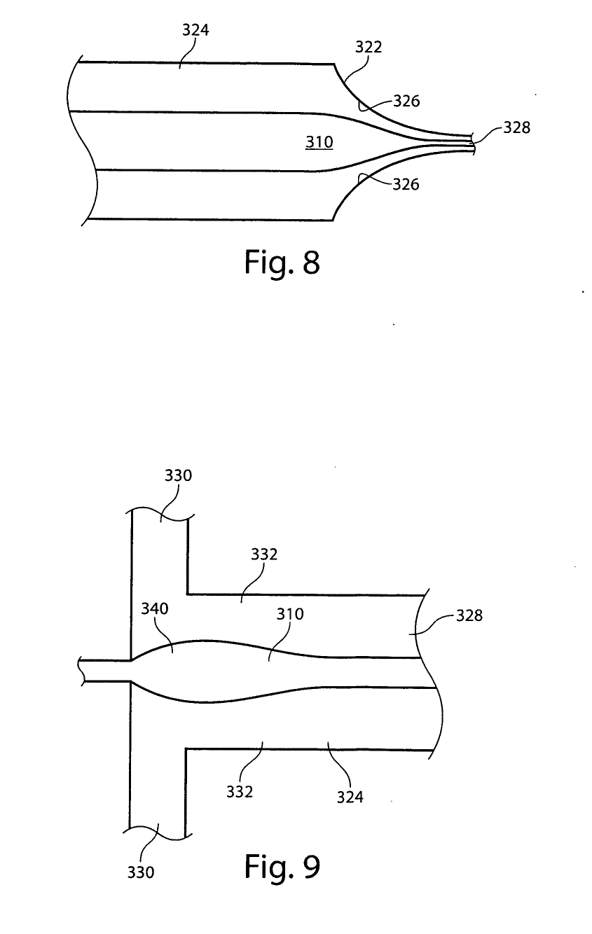

Different types of constrictions 322 can be used to create elongational flow 310 in a microchannel 324. By way of example, FIG. 8 shows a constriction 310 that includes a funnel formed by opposed walls 326 of a microchannel. The opposed walls of the funnel provide successively smaller cross-sectional area to carrier fluid as the carrier fluid moves downstream 328, and thus creates elongational flow therein. In some embodiments, constrictions comprise sheathing fluid introduction ports 330 that provide sheathing fluids 332 to the microchannel 324, as shown in FIG. 9. The sheathing fluids reduce the area available to the carrier fluid 340 as they are injected into the microchannel and thus create elongational flow 310. Still, other types of constrictions can be used to create elongational flow as aspects of the invention are not limited in this manner. As used herein, the term “constriction” refers to features within an apparatus that can be used to create elongational flow in fluid passing through the apparatus. Constrictions include, but are not limited to the above described examples. As used herein, the term “sheathing fluid” refers to any fluid introduced to the microchannel other than the carrier fluid or sample fluid. Sheathing fluids can be used to create elongational flow as described above, but can also be used to accomplish other objectives, as aspects of the invention are not limited in this regard.

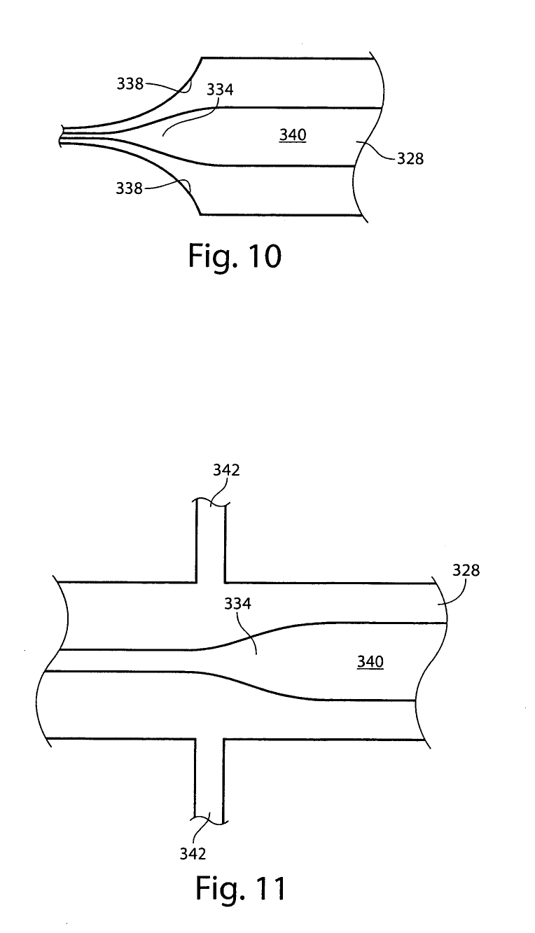

Divergent flow 334 can be created through various types of diffusion sections 336 of a microchannel 324. In some embodiments, diffusion sections include opposed walls 338 of a microchannel that form a funnel, as shown in FIG. 10. The funnel provides successively greater cross sectional area to the carrier fluid 340 as the carrier fluid moves downstream. When successively greater cross sectional area is provided to the carrier fluid, divergent flow 334 can be created. In some embodiments, divergent sections include channels 342 that remove portions of the carrier fluid or sheathing fluid from the microchannel to create divergent flow in the carrier fluid remaining in the microchannel, as shown in FIG. 11. Still, other mechanisms can be used to create divergent flow as aspects of the invention are not limited in this regard.

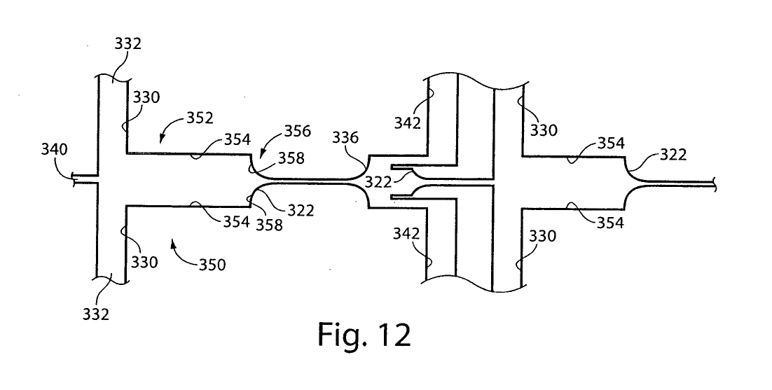

Devices used to create elongational flow, divergent flow, and/or uniform velocity flow may be combined within a microfluidic apparatus in various different ways. By way of example, FIG. 12 shows one embodiment of microfluidic device that has multiple features to create elongational flow, divergent flow, and uniform velocity flow. In an upstream portion 350, a pair of opposed sheathing fluid introduction ports 330 introduce sheathing flow 332 into the microchannel to create elongational flow 310 in a carrier fluid also introduced near the upstream portion as previously discussed with respect to FIG. 9. Immediately downstream from the sheathing fluid introduction ports is an area 352 of the microchannel with evenly spaced opposed walls 354. Here, uniform velocity flow may exist after the sheathing fluid and the carrier fluid reach equilibrium. Downstream from the evenly separated walls is a section 356 of the microchannel with opposed walls 358 that form a funnel 322. This particular funnel is a converging funnel that restricts cross sectional area available to the carrier fluid and creates elongational flow as discussed herein with respect to the embodiment of FIG. 8. Downstream from the converging funnel, is a diverging funnel 336 that creates divergent flow like that discussed with reference to FIG. 10. Additionally, fluid removal channels 342 are disposed downstream from the divergent funnel that may be used to create an additional divergent flow like those of FIG. 11. Disposed between the fluid removal channels is a central portion of the microchannel including another converging funnel 322 that may create elongational flow. After fluid has passed through this converging funnel, it again enters an area of the microchannel with opposed sheathing fluid introduction ports 330 followed by a section of microchannel with evenly spaced walls 354, and then followed by a converging funnel 322. It is to be appreciated that FIG. 12 shows but one embodiment of the present invention, and other combinations of features to create elongational flow, diverging flow, or uniform velocity flow may be combined in other manners.

In some embodiments, the amount of polymer relaxation that occurs between elongational flows is controlled by the arrangement of constrictions within a microchannel. Constrictions can be separated further from one another to allow a polymer passing through the microchannel more time to relax, or closer to allow less time to relax. In other embodiments, the velocity of the carrier fluid can be adjusted to alter the amount of time for polymer relaxation between elongational flows. For example, the velocity can be decreased so that, all else constant, a polymer may reside in uniform velocity flow for a longer time between elongational flows, and thus relax further. In many embodiments, such as those used to manipulate DNA, the DNA is allowed to relax for approximately 1 second between elongational flows.

Microfluidic devices associated with microfluidic flow parallelization and/or sequential elongational flows can be used with other microfluidic devices, such as any of those described in U.S. patent application Ser. No. 10/821,664 titled Advanced Microfluidics, now published as US 2005-0112606-A1.

Samples can be derived from virtually any source known or suspected to contain an agent of interest. Samples can be of solid, liquid or gaseous nature. They may be purified but usually are not. Different samples can be collected from different environments and prepared in the same manner by using the appropriate collecting device.

The samples to be tested can be a biological or bodily sample such as a tissue biopsy, urine, sputum, semen, stool, saliva and the like. The invention further contemplates preparation and analysis of samples that may be biowarfare targets. Air, liquids and solids that will come into contact with the greatest number of people are most likely to be biowarfare targets. Samples to be tested for the presence of such agents may be taken from an indoor or outdoor environment. Such biowarfare sampling can occur continuously, although this may not be necessary in every application. For example, in an airport setting, it may only be necessary to harvest randomly a sample near or around select baggage. In other instances, it may be necessary to continually monitor (and thus sample the environment). These instances may occur in “heightened alert” states. In some important embodiments, the sample is tested for the presence of a pathogen. Examples include samples to be tested for the presence of a pathogenic substances such as but not limited to food pathogens, water-borne pathogens, and aerosolized pathogens.

Liquid samples can be taken from public water supplies, water reservoirs, lakes, rivers, wells, springs, and commercially available beverages. Solids such as food (including baby food and formula), money (including paper and coin currencies), public transportation tokens, books, and the like can also be sampled via swipe, wipe or swab testing and placing the swipe, wipe or swab in a liquid for dissolution of any agents attached thereto. Based on the size of the swipe or swab and the volume of the corresponding liquid it must be placed in for agent dissolution, it may or may not be necessary to concentrate such liquid sample prior to further manipulation.

Air samples can be tested for the presence of normally airborne substances as well as aerosolized (or weaponized) chemicals or biologics that are not normally airborne. Air samples can be taken from a variety of places suspected of being biowarfare targets including public places such as airports, hotels, office buildings, government facilities, and public transportation vehicles such as buses, trains, airplanes, and the like.

Analysis of samples may embrace the use of one or more reagents (i.e., at least one reagent) that acts on or reacts with and thereby modifies a target agent. At least one reagent however is less than an infinite number of reagents as used herein and more commonly represents less than 1000, less than 100, less than 50, less than 20, less than 10 or less than 5. The nature of the reagents will vary depending on the analysis being performed using such reagent. The reagent may be a lysing agent (e.g., a detergent such as but not limited to deoxycholate), a labeling agent or probe (e.g., a sequence-specific nucleic acid probe), an enzyme (e.g., a nuclease such as a restriction endonuclease), an enzyme co-factor, a stabilizer (e.g., an anti-oxidant), and the like. One of ordinary skill in the art can envision other reagents to be used in the invention.

Additionally, the fluids used in the invention may contain other components such as buffering compounds (e.g., TRIS), chelating compounds (e.g., EDTA), ions (e.g., monovalent, divalent or trivalent cations or anions), salts, and the like.

The invention is not limited in the nature of the agent being analyzed (i.e., the target agent). These agents include but are not limited to cells and cell components (e.g., proteins and nucleic acids), chemicals and the like. These agents may be biohazardous agents. Target agents may be naturally occurring or non-naturally occurring, and this includes agents synthesized ex vivo but released into a natural environment. A plurality of agents is more than one and less than an infinite number. It includes less than 10¹⁰, less than 10⁹, less than, 10⁸, less than 10⁹, less than 10⁷, less than 10⁶, less than 10⁵, less than 10⁴, less than 5000, less than 1000, less than 500, less 100, less than 50, less than 25, less than 10 and less than 5, as well as every integer therebetween as if explicitly recited herein.

A “polymer” as used herein is a compound having a linear backbone to which monomers are linked together by linkages. The polymer is made up of a plurality of individual monomers. An individual monomer as used herein is the smallest building block that can be linked directly or indirectly to other building blocks (or monomers) to form a polymer. At a minimum, the polymer contains at least two linked monomers. The particular type of monomer will depend upon the type of polymer being analyzed. The polymer may be a nucleic acid, a peptide, a protein, a carbohydrate, an oligo- or polysaccharide, a lipid, etc. The polymer may be naturally occurring but it is not so limited.

In some embodiments, the polymer is capable of being bound to or by sequence- or structure-specific probes, wherein the sequence or structure recognized and bound by the probe is unique to that polymer or to a region of the polymer. It is possible to use a given probe for two or more polymers if a polymer is recognized by two or more probes, provided that the combination of probes is still specific for only a given polymer. A sample containing polymers, in some instances, can be analyzed as is without harvest and isolation of polymers contained therein.

In some embodiments, the method can be used to detect a plurality of different polymers in a sample.

As used herein, stretching of the polymer means that the polymer is provided in a substantially linear extended form rather than a compacted, coiled and/or folded form.

In some important embodiments, the polymers are nucleic acids. The term “nucleic acid” refers to multiple linked nucleotides (i.e., molecules comprising a sugar (e.g., ribose or deoxyribose) linked to an exchangeable organic base, which is either a pyrimidine (e.g., cytosine (C), thymidine (T) or uracil (U)) or a purine (e.g., adenine (A) or guanine (G)). “Nucleic acid” and “nucleic acid molecule” are used interchangeably and refer to oligoribonucleotides as well as oligodeoxyribonucleotides. The terms shall also include polynucleosides (i.e., a polynucleotide minus a phosphate) and any other organic base containing nucleic acid. The organic bases include adenine, uracil, guanine, thymine, cytosine and inosine.

In important embodiments, the nucleic acid is DNA or RNA. DNA includes genomic DNA (such as nuclear DNA and mitochondrial DNA), as well as in some instances complementary DNA (cDNA). RNA includes messenger RNA (mRNA), miRNA, and the like. The nucleic acid may be naturally or non-naturally occurring. Non-naturally occurring nucleic acids include but are not limited to bacterial artificial chromosomes (BACs) and yeast artificial chromosomes (YACs). Harvest and isolation of nucleic acids are routinely performed in the art and suitable methods can be found in standard molecular biology textbooks. (See, for example, Maniatis' Handbook of Molecular Biology.)

Preferably, prior amplification using techniques such as polymerase chain reaction (PCR) are not necessary. Accordingly, the polymer may be a non in vitro amplified nucleic acid. As used herein, a “non in vitro amplified nucleic acid” refers to a nucleic acid that has not been amplified in vitro using techniques such as polymerase chain reaction or recombinant DNA methods. A non in vitro amplified nucleic acid may however be a nucleic acid that is amplified in vivo (in the biological sample from which it was harvested) as a natural consequence of the development of the cells in vivo. This means that the non in vitro nucleic acid may be one which is amplified in vivo as part of locus amplification, which is commonly observed in some cell types as a result of mutation or cancer development.

As used herein with respect to linked units of a polymer including a nucleic acid, “linked” or “linkage” means two entities bound to one another by any physicochemical means. Any linkage known to those of ordinary skill in the art, covalent or non-covalent, is embraced. Natural linkages, which are those ordinarily found in nature connecting for example the individual units of a particular nucleic acid, are most common. Natural linkages include, for instance, amide, ester and thioester linkages. The individual units of a nucleic acid analyzed by the methods of the invention may be linked, however, by synthetic or modified linkages. Nucleic acids where the units are linked by covalent bonds will be most common but those that include hydrogen bonded units are also embraced by the invention. It is to be understood that all possibilities regarding nucleic acids apply equally to nucleic acid targets and nucleic acid probes, as discussed herein.

The nucleic acids may be double-stranded, although in some embodiments the nucleic acid targets are denatured and presented in a single-stranded form. This can be accomplished by modulating the environment of a double-stranded nucleic acid including singly or in combination increasing temperature, decreasing salt concentration, and the like. Methods of denaturing nucleic acids are known in the art.

Target nucleic acids (i.e., those of interest) commonly have a phosphodiester backbone because this backbone is most common in vivo. However, they are not so limited. Backbone modifications are known in the art. One of ordinary skill in the art is capable of preparing such nucleic acids without undue experimentation. The probes, if nucleic acid in nature, can also have backbone modifications such as those described herein.

Thus the nucleic acids may be heterogeneous in backbone composition thereby containing any possible combination of nucleic acid units linked together such as peptide nucleic acids (which have amino acid linkages with nucleic acid bases, and which are discussed in greater detail herein). In some embodiments, the nucleic acids are homogeneous in backbone composition.

Probes may be used to analyze polymers. As used herein, a probe is a molecule or compound that binds preferentially to the agent (e.g., a polymer) of interest (i.e., it has a greater affinity for the agent of interest than for other compounds). Its affinity for the agent of interest may be at least 2-fold, at least 5-fold, at least 10-fold, or more than its affinity for another compound. Probes with the greatest differential affinity are preferred in most embodiments. Binding of a probe to an agent may indicate the presence and location of a target site in the target agent, or it may simply indicate the presence of the agent, depending on user requirements. As used herein, a target agent that is bound by a probe is “labeled” with the probe and/or its detectable label.

The probes can be of any nature including but not limited to nucleic acid (e.g., aptamers), peptide, carbohydrate, lipid, and the like, or some combination thereof. A nucleic acid based probe such as an oligonucleotide can be used to recognize and bind DNA or RNA. The nucleic acid based probe can be DNA, RNA, LNA or PNA, although it is not so limited. It can also be a combination of one or more of these elements and/or can comprise other nucleic acid mimics. With the advent of aptamer technology, it is possible to use nucleic acid based probes in order to recognize and bind a variety of compounds, including peptides and carbohydrates, in a structurally, and thus sequence, specific manner. Other probes for nucleic acid targets include but are not limited to sequence-specific major and minor groove binders and intercalators, nucleic acid binding peptides or proteins, etc.

As used herein a “peptide” is a polymer of amino acids connected preferably but not solely with peptide bonds. The probe may be an antibody or an antibody fragment. Antibodies include IgG, IgA, IgM, IgE, IgD as well as antibody variants such as single chain antibodies. Antibody fragments contain an antigen-binding site and thus include but are not limited to Fab and F(ab)₂ fragments.

The probes may bind to the target polymer in a sequence-specific manner. “Sequence-specific” when used in the context of a nucleic acid means that the probe recognizes a particular linear (or in some instances quasi-linear) arrangement of nucleotides or derivatives thereof. In some embodiments, the probes are “polymer-specific” meaning that they bind specifically to a particular polymer, possibly by virtue of a particular sequence or structure unique to that polymer.

In some instances, nucleic acid probes will form at least a Watson-Crick bond with a target nucleic acid. In other instances, the nucleic acid probe can form a Hoogsteen bond with the target nucleic acid, thereby forming a triplex. A nucleic acid probe that binds by Hoogsteen binding enters the major groove of a nucleic acid polymer and hybridizes with the bases located there. Examples of these latter probes include molecules that recognize and bind to the minor and major grooves of nucleic acids (e.g., some forms of antibiotics). In some embodiments, the nucleic acid probes can form both Watson-Crick and Hoogsteen bonds with the nucleic acid polymer. BisPNA probes, for instance, are capable of both Watson-Crick and Hoogsteen binding to a nucleic acid.

The nucleic acid probes of the invention can be any length ranging from at least 4 nucleotides to in excess of 1000 nucleotides. In preferred embodiments, the probes are 5-100 nucleotides in length, more preferably between 5-25 nucleotides in length, and even more preferably 5-12 nucleotides in length. The length of the probe can be any length of nucleotides between and including the ranges listed herein, as if each and every length was explicitly recited herein. Thus, the length may be at least 5 nucleotides, at least 10 nucleotides, at least 15 nucleotides, at least 20 nucleotides, or at least 25 nucleotides, or more, in length. The length may range from at least 4, at least 5, at least 6, at least 7, at least 8, at least 9, at least 10, at least 12, at least 15, at least 20, at least 25, at least 50, at least 75, at least 100, at least 150, at least 200, at least 250, at least 500, or more nucleotides (including every integer therebetween as if explicitly recited herein).

It should be understood that not all residues of the probe need hybridize to complementary residues in the nucleic acid target. For example, the probe may be 50 residues in length, yet only 25 of those residues hybridize to the nucleic acid target. Preferably, the residues that hybridize are contiguous with each other.

The probes are preferably single-stranded, but they are not so limited. For example, when the probe is a bisPNA it can adopt a secondary structure with the nucleic acid polymer resulting in a triple helix conformation, with one region of the bisPNA clamp forming Hoogsteen bonds with the backbone of the polymer and another region of the bisPNA clamp forming Watson-Crick bonds with the nucleotide bases of the polymer.

The nucleic acid probe hybridizes to a complementary sequence within the nucleic acid polymer. The specificity of binding can be manipulated based on the hybridization conditions. For example, salt concentration and temperature can be modulated in order to vary the range of sequences recognized by the nucleic acid probes. Those of ordinary skill in the art will be able to determine optimum conditions for a desired specificity.

In some embodiments, the probes may be molecular beacons. When not bound to their targets, the molecular beacon probes form a hairpin structure and do not emit fluorescence since one end of the molecular beacon is a quencher molecule. However, when bound to their targets, the fluorescent and quenching ends of the probe are sufficiently separated so that the fluorescent end can now emit.

The probes may be nucleic acids, as described herein, or nucleic acid derivatives. As used herein, a “nucleic acid derivative” is a non-naturally occurring nucleic acid or a unit thereof. Nucleic acid derivatives may contain non-naturally occurring elements such as non-naturally occurring nucleotides and non-naturally occurring backbone linkages. These include substituted purines and pyrimidines such as C-5 propyne modified bases, 5-methylcytosine, 2-aminopurine, 2-amino-6-chloropurine, 2,6-diaminopurine, hypoxanthine, 2-thiouracil and pseudoisocytosine. Other such modifications are well known to those of skill in the art.

The nucleic acid derivatives may also encompass substitutions or modifications, such as in the bases and/or sugars. For example, they include nucleic acids having backbone sugars which are covalently attached to low molecular weight organic groups other than a hydroxyl group at the 3′ position and other than a phosphate group at the 5′ position. Thus, modified nucleic acids may include a 2′-O-alkylated ribose group. In addition, modified nucleic acids may include sugars such as arabinose instead of ribose.

The probes if comprising nucleic acid components can be stabilized in part by the use of backbone modifications. The invention intends to embrace, in addition to the peptide and locked nucleic acids discussed herein, the use of the other backbone modifications such as but not limited to phosphorothioate linkages, phosphodiester modified nucleic acids, combinations of phosphodiester and phosphorothioate nucleic acid, methylphosphonate, alkylphosphonates, phosphate esters, alkylphosphonothioates, phosphoramidates, carbamates, carbonates, phosphate triesters, aecetamidates, carboxymethyl esters, methylphosphorothioate, phosphorodithioate, p-ethoxy, and combinations thereof.

In some embodiments, the probe is a nucleic acid that is a peptide nucleic acid (PNA), a bisPNA clamp, a pseudocomplementary PNA, a locked nucleic acid (LNA), DNA, RNA, or co-nucleic acids of the above such as DNA-LNA co-nucleic acids siRNA or miRNA or RNAi molecules can be similarly used.

In some embodiments, the probe is a peptide nucleic acid (PNA), a bisPNA clamp, a locked nucleic acid (LNA), a ssPNA, a pseudocomplementary PNA (pcPNA), a two-armed PNA (as described in co-pending U.S. Patent Application having Ser. No. 10/421,644 and publication number US 2003-0215864 A1 and published Nov. 20, 2003, and PCT application having Ser. No. PCT/US03/12480 and publication number WO 03/091455A1 and published Nov. 6, 2003, filed on Apr. 23, 2003), or co-polymers thereof (e.g., a DNA-LNA co-polymer).

Other backbone modifications, particularly those relating to PNAs, include peptide and amino acid variations and modifications. Thus, the backbone constituents of PNAs may be peptide linkages, or alternatively, they may be non-peptide linkages. Examples include acetyl caps, amino spacers such as 8-amino-3,6-dioxaoctanoic acid (referred to herein as O-linkers), amino acids such as lysine (particularly useful if positive charges are desired in the PNA), and the like. Various PNA modifications are known and probes incorporating such modifications are commercially available from sources such as Boston Probes, Inc.

As stated herein, the agent (e.g., the polymer) may be labeled. As an example, if the agent is a nucleic acid, it may be labeled through the use of sequence-specific probes that bind to the polymer in a sequence-specific manner. The sequence-specific probes are labeled with a detectable label (e.g., a fluorophore or a radioisotope). The nucleic acid however can also be synthesized in a manner that incorporates fluorophores directly into the growing nucleic acid. For example, this latter labeling can be accomplished by chemical means or by the introduction of active amino or thiol groups into nucleic acids. (Proudnikov and Mirabekov, Nucleic Acid Research, 24:4535-4532, 1996.) An extensive description of modification procedures that can be performed on a nucleic acid polymer can be found in Hermanson, G. T., Bioconjugate Techniques, Academic Press, Inc., San Diego, 1996, which is incorporated by reference herein.

There are several known methods of direct chemical labeling of DNA (Hermanson, 1996; Roget et al., 1989; Proudnikov and Mirabekov, 1996). One of the methods is based on the introduction of aldehyde groups by partial depurination of DNA. Fluorescent labels with an attached hydrazine group are efficiently coupled with the aldehyde groups and the hydrazine bonds are stabilized by reduction with sodium labeling efficiencies around 60%. The reaction of cytosine with bisulfite in the presence of an excess of an amine fluorophore leads to transamination at the N4 position (Hermanson, 1996). Reaction conditions such as pH, amine fluorophore concentration, and incubation time and temperature affect the yield of products formed. At high concentrations of the amine fluorophore (3M), transamination can approach 100% (Draper and Gold, 1980).

In addition to the above method, it is also possible to synthesize nucleic acids de novo (e.g., using automated nucleic acid synthesizers) using fluorescently labeled nucleotides. Such nucleotides are commercially available from suppliers such as Amersham Pharmacia Biotech, Molecular Probes, and New England Nuclear/Perkin Elmer.

Probes are generally labeled with a detectable label. A detectable label is a moiety, the presence of which can be ascertained directly or indirectly. Generally, detection of the label involves the creation of a detectable signal such as for example an emission of energy. The label may be of a chemical, peptide or nucleic acid nature although it is not so limited. The nature of label used will depend on a variety of factors, including the nature of the analysis being conducted, the type of the energy source and detector used and the type of polymer and probe. The label should be sterically and chemically compatible with the constituents to which it is bound.

The label can be detected directly for example by its ability to emit and/or absorb electromagnetic radiation of a particular wavelength. A label can be detected indirectly for example by its ability to bind, recruit and, in some cases, cleave another moiety which itself may emit or absorb light of a particular wavelength (e.g., an epitope tag such as the FLAG epitope, an enzyme tag such as horseradish peroxidase, etc.). Generally the detectable label can be selected from the group consisting of directly detectable labels such as a fluorescent molecule (e.g., fluorescein, rhodamine, tetramethylrhodamine, R-phycoerythrin, Cy-3, Cy-5, Cy-7, Texas Red, Phar-Red, allophycocyanin (APC), fluorescein amine, eosin, dansyl, umbelliferone, 5-carboxyfluorescein (FAM), 2′7′-dimethoxy-4′5′-dichloro-6-carboxyfluorescein (JOE), 6 carboxyrhodamine (R6G), N,N,N′,N′-tetramethyl-6-carboxyrhodamine (TAMRA), 6-carboxy-X-rhodamine (ROX), 4-(4′-dimethylaminophenylazo) benzoic acid (DABCYL), 5-(2′-aminoethyl) aminonaphthalene-1-sulfonic acid (EDANS), 4-acetamido-4′-isothiocyanatostilbene-2,2′disulfonic acid, acridine, acridine isothiocyanate, r-amino-N-(3-vinylsulfonyl)phenylnaphthalimide-3,5, disulfonate (Lucifer Yellow VS), N-(4-anilino-1-naphthyl)maleimide, anthranilamide, Brilliant Yellow, coumarin, 7-amino-4-methylcoumarin, 7-amino-4-trifluoromethylcouluarin (Coumarin 151), cyanosine, 4′,6-diaminidino-2-phenylindole (DAPI), 5′, 5″-diaminidino-2-phenylindole (DAPI), 5′, 5″-dibromopyrogallol-sulfonephthalein (Bromopyrogallol Red), 7-diethylamino-3-(4′-isothiocyanatophenyl)-4-methylcoumarin diethylenetriamine pentaacetate, 4,4′-diisothiocyanatodihydro-stilbene-2,2′-disulfonic acid, 4,4′-diisothiocyanatostilbene-2, 2′-disulfonic acid, 4-dimethylaminophenylazophenyl-4′-isothiocyanate (DABITC), eosin isothiocyanate, erythrosin B, erythrosin isothiocyanate, ethidium, 5-(4,6-dichlorotriazin-2-yl) aminofluorescein (DTAF), QFITC (XRITC), fluorescamine, IR144, IR1446, Malachite Green isothiocyanate, 4-methylumbelliferone, ortho cresolphthalein, nitrotyrosine, pararosaniline, Phenol Red, B-phycoerythrin, o-phthaldialdehyde, pyrene, pyrene butyrate, succinimidyl 1-pyrene butyrate, Reactive Red 4 (Cibacron.RTM.Brilliant Red 3B-A), lissamine rhodamine B sulfonyl chloride, rhodamine B, rhodamine 123, rhodamine X, sulforhodamine B, sulforhodamine 101, sulfonyl chloride derivative of sulforhodamine 101, tetramethyl rhodamine, riboflavin, rosolic acid, and terbium chelate derivatives), a chemiluminescent molecule, a bioluminescent molecule, a chromogenic molecule, a radioisotope (e.g., p³² or H³, ¹⁴C, ¹²⁵I and ¹³¹I), an electron spin resonance molecule (such as for example nitroxyl radicals), an optical or electron density molecule, an electrical charge transducing or transferring molecule, an electromagnetic molecule such as a magnetic or paramagnetic bead or particle, a semiconductor nanocrystal or nanoparticle (such as quantum dots described for example in U.S. Pat. No. 6,207,392 and commercially available from Quantum Dot Corporation and Evident Technologies), a colloidal metal, a colloid gold nanocrystal, a nuclear magnetic resonance molecule, and the like.

The detectable label can also be selected from the group consisting of indirectly detectable labels such as an enzyme (e.g., alkaline phosphatase, horseradish peroxidase, β-galactosidase, glucoamylase, lysozyme, luciferases such as firefly luciferase and bacterial luciferase (U.S. Pat. No. 4,737,456); saccharide oxidases such as glucose oxidase, galactose oxidase, and glucose-6-phosphate dehydrogenase; heterocyclic oxidases such as uricase and xanthine oxidase coupled to an enzyme that uses hydrogen peroxide to oxidize a dye precursor such as HRP, lactoperoxidase, or microperoxidase), an enzyme substrate, an affinity molecule, a ligand, a receptor, a biotin molecule, an avidin molecule, a streptavidin molecule, an antigen (e.g., epitope tags such as the FLAG or HA epitope), a hapten (e.g., biotin, pyridoxal, digoxigenin fluorescein and dinitrophenol), an antibody, an antibody fragment, a microbead, and the like. Antibody fragments include Fab, F(ab)₂, Fd and antibody fragments which include a CDR3 region.

In some embodiments, the detectable label is a member of a FRET fluorophore pair. FRET fluorophore pairs are two fluorophores that are capable of undergoing FRET to produce or eliminate a detectable signal when positioned in proximity to one another. Examples of donors include Alexa 488, Alexa 546, BODIPY 493, Oyster 556, Fluor (FAM), Cy3 and TMR (Tamra). Examples of acceptors include Cy5, Alexa 594, Alexa 647 and Oyster 656. Cy5 can work as a donor with Cy3, TMR or Alexa 546, as an example. FRET should be possible with any fluorophore pair having fluorescence maxima spaced at 50-100 nm from each other.

The polymer may be labeled in a sequence non-specific manner. For example, if the polymer is a nucleic acid such as DNA, then its backbone may be stained with a backbone label. Examples of backbone stains that label nucleic acids in a sequence non-specific manner include intercalating dyes such as phenanthridines and acridines (e.g., ethidium bromide, propidium iodide, hexidium iodide, dihydroethidium, ethidium homodimer-1 and -2, ethidium monoazide, and ACMA); minor grove binders such as indoles and imidazoles (e.g., Hoechst 33258, Hoechst 33342, Hoechst 34580 and DAPI); and miscellaneous nucleic acid stains such as acridine orange (also capable of intercalating), 7-AAD, actinomycin D, LDS751, and hydroxystilbamidine. All of the aforementioned nucleic acid stains are commercially available from suppliers such as Molecular Probes, Inc.

Still other examples of nucleic acid stains include the following dyes from Molecular Probes: cyanine dyes such as SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21 , -23, -12, -11, -20, -22, -15, -14, -25 (green), SYTO-81, -80, -82, -83, -84, -85 (orange), SYTO-64, -17, -59, -61, -62, -60, -63 (red).

As used herein, “conjugated” means two entities stably bound to one another by any physiochemical means. It is important that the nature of the attachment is such that it does not substantially impair the effectiveness of either entity. Keeping these parameters in mind, any covalent or non-covalent linkage known to those of ordinary skill in the art may be employed. In some embodiments, covalent linkage is preferred. Noncovalent conjugation includes hydrophobic interactions, ionic interactions, high affinity interactions such as biotin-avidin and biotin-streptavidin complexation and other affinity interactions. Such means and methods of attachment are known to those of ordinary skill in the art.

The various components described herein can be conjugated to each other by any mechanism known in the art. For instance, functional groups which are reactive with various labels include, but are not limited to (functional group: reactive group of light emissive compound), activated ester:amines or anilines; acyl azide:amines or anilines; acyl halide: amines, anilines, alcohols or phenols; acyl nitrile:alcohols or phenols; aldehyde:amines or anilines; alkyl halide:amines, anilines, alcohols, phenols or thiols; alkyl sulfonate:thiols, alcohols or phenols; anhydride:alcohols, phenols, amines or anilines; aryl halide:thiols; aziridine:thiols or thioethers; carboxylic acid:amines, anilines, alcohols or alkyl halides; diazoalkane:carboxylic acids; epoxide:thiols; haloacetamide:thiols; halotriazine:amines, anilines or phenols; hydrazine:aldehydes or ketones; hydroxyamine:aldehydes or ketones; imido ester:amines or anilines; isocyanate:amines or anilines; and isothiocyanate:amines or anilines.

Linkers can be any of a variety of molecules, preferably nonactive, such as nucleotides or multiple nucleotides, straight or even branched saturated or unsaturated carbon chains of C₁-C₃₀, phospholipids, amino acids, and in particular glycine, and the like, whether naturally occurring or synthetic. Additional linkers include alkyl and alkenyl carbonates, carbamates, and carbamides. These are all related and may add polar functionality to the linkers such as the C₁-C₃₀ previously mentioned. As used herein, the terms linker and spacer are used interchangeably.

A wide variety of spacers can be used, many of which are commercially available, for example, from sources such as Boston Probes, Inc. (now Applied Biosystems). Spacers are not limited to organic spacers, and rather can be inorganic also (e.g., —O—Si—O—, or O—P—O—). Additionally, they can be heterogeneous in nature (e.g., composed of organic and inorganic elements). Essentially, any molecule having the appropriate size restrictions and capable of being linked to the various components such as fluorophore and probe can be used as a linker. Examples include the E linker (which also functions as a solubility enhancer), the X linker which is similar to the E linker, the O linker which is a glycol linker, and the P linker which includes a primary aromatic amino group (all supplied by Boston Probes, Inc., now Applied Biosystems). Other suitable linkers are acetyl linkers, 4-aminobenzoic acid containing linkers, Fmoc linkers, 4-aminobenzoic acid linkers, 8-amino-3, 6-dioxactanoic acid linkers, succinimidyl maleimidyl methyl cyclohexane carboxylate linkers, succinyl linkers, and the like. Another example of a suitable linker is that described by Haralambidis et al. in U.S. Pat. No. 5,525,465, issued on Jun. 11, 1996.

The conjugations or modifications described herein employ routine chemistry, which is known to those skilled in the art of chemistry. The use of linkers such as mono- and hetero-bifunctional linkers is documented in the literature (e.g., Hermanson, 1996) and will not be repeated here.

The linker molecules may be homo-bifunctional or hetero-bifunctional cross-linkers, depending upon the nature of the molecules to be conjugated. Homo-bifunctional cross-linkers have two identical reactive groups. Hetero-bifunctional cross-linkers are defined as having two different reactive groups that allow for sequential conjugation reaction. Various types of commercially available cross-linkers are reactive with one or more of the following groups: primary amines, secondary amines, sulphydryls, carboxyls, carbonyls and carbohydrates. Examples of amine-specific cross-linkers are bis(sulfosuccinimidyl)suberate, bis[2-(succinimidooxycarbonyloxy)ethyl]sulfone, disuccinimidyl suberate, disuccinimidyl tartarate, dimethyl adipimate.2 HCl, dimethyl pimelimidate.2 HCl, dimethyl suberimidate.2 HCl, and ethylene glycolbis-[succinimidyl-[succinate]]. Cross-linkers reactive with sulfhydryl groups include bismaleimidohexane, 1,4-di-[3′-(2′-pyridyldithio)-propionamido)]butane, 1-[p-azidosalicylamido]-4-[iodoacetamido]butane, and N-[4-(p-azidosalicylamido)butyl]-3′-[2′-pyridyldithio]propionamide. Cross-linkers preferentially reactive with carbohydrates include azidobenzoyl hydrazine. Cross-linkers preferentially reactive with carboxyl groups include 4-[p-azidosalicylamido]butylamine. Heterobifunctional cross-linkers that react with amines and sulfhydryls include N-succinimidyl-3-[2-pyridyldithio]propionate, succinimidyl [4-iodoacetyl]aminobenzoate, succinimidyl 4-[N-maleimidomethyl]cyclohexane-1-carboxylate, m-maleimidobenzoyl-N-hydroxysuccinimide ester, sulfosuccinimidyl 6-[3-[2-pyridyldithio]propionamido]hexanoate, and sulfosuccinimidyl 4-[N-maleimidomethyl]cyclohexane-1-carboxylate. Heterobifunctional cross-linkers that react with carboxyl and amine groups include 1-ethyl-3-[3-dimethylaminopropyl]-carbodiimide hydrochloride. Heterobifunctional cross-linkers that react with carbohydrates and sulfhydryls include 4-[N-maleimidomethyl]-cyclohexane-1-carboxylhydrazide.2 HCl, 4-(4-N-maleimidophenyl)-butyric acid hydrazide.2 HCl, and 3-[2-pyridyldithio]propionyl hydrazide. The cross-linkers are bis-[β-4-azidosalicylamido)ethyl]disulfide and glutaraldehyde.

Amine or thiol groups may be added at any nucleotide of a synthetic nucleic acid so as to provide a point of attachment for a bifunctional cross-linker molecule. The nucleic acid may be synthesized incorporating conjugation-competent reagents such as Uni-Link AminoModifier, 3′-DMT-C6-Amine-ON CPG, AminoModifier II, N-TFA-C6-AminoModifier, C6-ThiolModifier, C6-Disulfide Phosphoramidite and C6-Disulfide CPG (Clontech, Palo Alto, Calif.).

Non-covalent methods of conjugation may also be used to bind a detectable label to a probe, for example. Non-covalent conjugation includes hydrophobic interactions, ionic interactions, high affinity interactions such as biotin-avidin and biotin-streptavidin complexation and other affinity interactions. As an example, a molecule such as avidin may be attached the nucleic acid, and its binding partner biotin may be attached to the probe.

In some instances, it may be desirable to use a linker or spacer comprising a bond that is cleavable under certain conditions. For example, the bond can be one that cleaves under normal physiological conditions or that can be caused to cleave specifically upon application of a stimulus such as light. Readily cleavable bonds include readily hydrolyzable bonds, for example, ester bonds, amide bonds and Schiff's base-type bonds. Bonds which are cleavable by light are known in the art.

The agent (e.g., the polymer) may be analyzed using a single molecule analysis system (e.g., a single polymer analysis system). A single molecule detection system is capable of analyzing single molecules separately from other molecules. Such a system may be capable of analyzing single molecules in a linear manner and/or in their totality. In certain embodiments in which detection is based predominately on the presence or absence of a signal, linear analysis may not be required. However, there are other embodiments embraced by the invention which would benefit from the ability to analyze linearly molecules (preferably nucleic acids) in a sample. These include applications in which the sequence of the nucleic acid is desired, or in which the polymers are distinguished based on spatial labeling pattern rather than a unique detectable label.

Thus, the polymers can be analyzed using linear polymer analysis systems. A linear polymer analysis system is a system that analyzes polymers such as nucleic acids, in a linear manner (i.e., starting at one location on the polymer and then proceeding linearly in either direction therefrom). As a polymer is analyzed, the detectable labels attached to it are detected in either a sequential or simultaneous manner. When detected simultaneously, the signals usually form an image of the polymer, from which distances between labels can be determined. When detected sequentially, the signals are viewed in histogram (signal intensity vs. time) that can then be translated into a map, with knowledge of the velocity of the polymer. It is to be understood that in some embodiments, the polymer is attached to a solid support, while in others it is free flowing. In either case, the velocity of the polymer as it moves past, for example, an interaction station or a detector, will aid in determining the position of the labels relative to each other and relative to other detectable markers that may be present on the polymer.

An example of a suitable system is the GeneEngine™ (U.S. Genomics, Inc., Woburn, Mass.). The Gene Engine™ system is described in PCT patent applications WO98/35012 and WO00/09757, published on Aug. 13, 1998, and Feb. 24, 2000, respectively, and in issued U.S. Pat. NO. 6,355,420 B1, issued Mar. 12, 2002. The contents of these applications and patent, as well as those of other applications and patents, and references cited herein are incorporated by reference herein in their entirety. This system is both a single molecule analysis system and a linear polymer analysis system. It allows, for example, single nucleic acids to be passed through an interaction station in a linear manner, whereby the nucleotides in the nucleic acid are interrogated individually in order to determine whether there is a detectable label conjugated to the nucleic acid. Interrogation involves exposing the nucleic acid to an energy source such as optical radiation of a set wavelength. The mechanism for signal emission and detection will depend on the type of label sought to be detected, as described herein.

The systems described herein will encompass at least one detection system. The nature of such detection systems will depend upon the nature of the detectable label. The detection system can be selected from any number of detection systems known in the art. These include an electron spin resonance (ESR) detection system, a charge coupled device (CCD) detection system, a fluorescent detection system, an electrical detection system, a photographic film detection system, a chemiluminescent detection system, an enzyme detection system, an atomic force microscopy (AFM) detection system, a scanning tunneling microscopy (STM) detection system, an optical detection system, a nuclear magnetic resonance (NMR) detection system, a near field detection system, and a total internal reflection (TIR) detection system, many of which are electromagnetic detection systems.

Other single molecule nucleic acid analytical methods can also be used to analyze nucleic acid targets following the chamber based processing of the invention. These include fiber-fluorescence in situ hybridization (fiber-FISH) (Bensimon, A. et al., Science 265(5181):2096-2098 (1997)). In fiber-FISH, nucleic acid molecules are elongated and fixed on a surface by molecular combing. Hybridization with fluorescently labeled probe sequences allows determination of sequence landmarks on the nucleic acid molecules. The method requires fixation of elongated molecules so that molecular lengths and/or distances between markers can be measured. Pulse field gel electrophoresis can also be used to analyze the labeled nucleic acid molecules. Pulse field gel electrophoresis is described by Schwartz, D. C. et al., Cell 37(1):67-75 (1984). Other nucleic acid analysis systems are described by Otobe, K. et al., Nucleic Acids Res. 29(22):E109 (2001), Bensimon, A. et al. in U.S. Pat. No. 6,248,537, issued Jun. 19, 2001, Herrick, J. et al., Chromosome Res. 7(6):409:423 (1999), Schwartz in U.S. Pat. No. 6,150,089 issued Nov. 21, 2000 and U.S. Pat. No. 6,294,136, issued Sep. 25, 2001. Other linear polymer analysis systems can also be used, and the invention is not intended to be limited to solely those listed herein.

### EQUIVALENTS

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the invention. The advantages and objects of the invention are not necessarily encompassed by each embodiment of the invention.

All references, patents and patent applications that are recited in this application are incorporated by reference herein in their entirety. In case of conflict, the present specification, including definitions, will control.

What is claimed is:

1. A microfluidic apparatus comprising:
a microchannel having opposed walls, an upstream portion and a downstream portion, the microchannel constructed and arranged to transport fluid sample from the upstream portion toward the downstream portion;
a plurality of sample introduction ports that each provide a fluid sample to the microchannel such that the fluid sample from each of the plurality of sample introduction ports flows toward the downstream portion from the upstream portion; and
at least one sheathing fluid introduction port positioned to provide a sheathing fluid to the microchannel such that the sheathing fluid from each sheathing fluid introduction port separates two of the plurality of fluid samples from one another as the fluid samples move toward the downstream portion.

2-23. (canceled)

24. A method of moving polymers through a microchannel, the method comprising:
providing a microchannel having an upstream portion, a downstream portion, and opposed walls that extend therebetween, the microchannel constructed and arranged to transport fluid sample from the upstream portion toward the downstream portion;
providing a plurality of fluid samples and at least one sheathing fluid to the microchannel;
flowing the plurality of fluid samples in the microchannel toward the downstream portion; and
flowing the at least one sheathing fluid in the microchannel toward the downstream portion such that each of the at least one sheathing fluid separates two of the plurality of fluid samples from one another as the fluid samples move toward the downstream portion.

25. The method of claim 24, wherein flowing the plurality of fluid samples consists of flowing two fluid samples that are separated by a single sheathing fluid.

26. (canceled)

27. The method of claim 24, wherein each of the plurality of fluid samples is separated from adjacent fluid samples by fewer than 1 micron.

28. The method of claim 24, further comprising:
increasing a flow rate of one of the sheathing fluids such that the one sheathing fluid further separates adjacent fluid samples.

29. The method of claim 24, wherein the opposed walls form a funnel adapted to create a velocity gradient in each of the plurality of fluid samples.

30. The method of claim 24, further comprising:
flowing a pair of wall sheathing fluids in the microchannel such that each of the wall sheathing fluids separates one of the opposed walls from one of the plurality of fluid samples as the plurality of fluid samples move toward the downstream portion.

31. The method of claim 30, wherein the pair of wall sheathing fluids create a velocity gradient in each of the plurality of fluid samples.

32-34. (canceled)

35. The method of claim 34, further comprising:
supplying each of the at least two wall sheathing fluids to the microchip through a common supply port on the microchip.

36. The method of claim 35, further comprising:
supplying each of the at least one sheathing fluids to the microchip through the common supply port.

37. (canceled)

38. The method of claim 24, wherein flowing the plurality of fluid samples comprises flowing each of the plurality of fluid samples toward a detection zone.

39. (canceled)

40. The method of claim 24, wherein the plurality of fluid samples have a different viscosity than the at least one sheathing fluid.

41-48. (canceled)

49. An apparatus for manipulating a polymer in fluid, the apparatus comprising:
a microchannel having opposed walls, an upstream portion, and a downstream portion, the microchannel constructed and arranged to transport a carrier fluid such that, when present in the carrier fluid, the polymer flows from the upstream portion toward the downstream portion;
a first constriction adapted to create a first elongational flow for manipulating the polymer within the carrier fluid as the carrier fluid moves toward the downstream portion;
a second constriction adapted to create a second elongational flow for manipulating the polymer within the carrier fluid as the carrier fluid moves toward the downstream portion, the second elongational flow positioned downstream from and separated from the first elongational flow.

50-68. (canceled)

69. A method of manipulating a polymer in a carrier fluid, the method comprising:
providing a microchannel adapted to deliver a polymer carrier fluid, such that when the polymer is present in the carrier fluid, the polymer flows from an upstream portion toward a downstream portion of the microchannel;
providing the polymer carrier fluid containing the polymer to the microchannel;
subjecting the polymer in the carrier fluid to a first elongational flow as the carrier fluid moves toward the downstream portion; and
subjecting the polymer in the carrier fluid to a second elongational flow as the carrier fluid moves toward the downstream portion, the second elongational flow being downstream from and separated from the first elongational flow.

70. The method of claim 69, further comprising:
subjecting at least a portion of the polymer in the carrier fluid to uniform velocity flow after subjecting the polymer to the first elongational flow and before subjecting any portions of the polymer to the second elongational flow.

71-72. (canceled)

73. The method of claim 69, further comprising:
subjecting at least a portion of the polymer in the carrier fluid to divergent flow after subjecting the polymer to the first elongational flow and before subjecting the polymer to the second elongational flow.

74-75. (canceled)

76. The method of claim 73, wherein subjecting at least a portion of the polymer to divergent flow comprises removing fluid from the microchannel, such that the microchannel has successively greater cross sectional area available to the carrier fluid remaining in the channel that moves toward the downstream portion.

77. (canceled)

78. The method of claim 69, wherein subjecting the polymer in the carrier fluid to the first elongational flow comprises passing the carrier fluid through a portion of the microchannel that provides successively less cross-sectional area to the carrier fluid as the carrier fluid moves toward the downstream portion.

79. The method of claim 69, wherein subjecting the polymer in the carrier fluid to the second elongational flow comprises introducing sheathing fluid into the microchannel to create the second elongational flow in the carrier fluid.

80. (canceled)

81. The method of claim 69, further comprising:
subjecting the polymer in the carrier fluid to a third elongational flow as the carrier fluid moves toward the downstream portion, the third elongational flow being downstream and separated from the second elongational flow.

82-88. (canceled)
